(19) United States
(12) Patent Application Publication
(10) Pub. No.: US 2026/0179912 A1
(43) Pub. Date: Jun. 25, 2026

(54) LITHIUM-ION BATTERIES WITH HIGH CAPACITY AT LOW TEMPERATURES AND METHOD OF MAKING

(71) Applicant: Board of Regents of the NV System of Higher Education on behalf of the University of NV, Reno, Reno, NV (US)

(72) Inventors: Dev Chidambaram, Reno, NV (US); Jason Mennel, Reno, NV (US)

(21) Appl. No.: 19/180,695

(22) Filed: Apr. 16, 2025

Related U.S. Application Data
(60) Provisional application No. 63/634,904, filed on Apr. 16, 2024.

(51) Int. Cl. H01M 4/134; H01M 4/1395; H01M 4/62; H01M 10/0525; H01M 10/0567; H01M 10/0568; H01M 10/0569; H01M 10/42

(52) U.S. Cl. CPC H01M 4/134; H01M 4/1395; H01M 4/623; H01M 10/0525; H01M 10/0567; H01M 10/0568; H01M 10/0569; H01M 10/4235; H01M 2300/0037

(57) ABSTRACT

Embodiments herein relate to lithium-ion batteries with high capacity at low temperatures, to electrodes for such batteries, to a method for fabricating an electrode, and to a method for preparing a membrane. In one aspect, a method for fabricating an electrode for a Lithium-ion battery includes combining silicon nanoparticles, a binder, conductive carbon and a metal additive in a solvent to form a slurry, casting the slurry onto a copper foil to form a film, and drying the film in a vacuum oven. The method can further include heat treating the film after the drying.

### CROSS-REFERENCE TO RELATED APPLICATIONS

This application claims the benefit of U.S. provisional pat. app. 63/634,904, entitled “Lithium-Ion Batteries With High Capacity At Low Temperatures And Method Of Making,” filed Apr. 16, 2024, and incorporated herein by reference.

### STATEMENT REGARDING FEDERALLY SPONSORED RESEARCH OR DEVELOPMENT

This invention was made with government support under contract number 80NSSC19M0152 awarded by the National Aeronautics and Space Administration. The government has certain rights in the invention.

### BACKGROUND

Lithium-ion batteries are rechargeable batteries commonly used in electronic devices ranging from smartphones and laptops to electric vehicles (EVs) and grid storage systems. These batteries exhibit qualities such as high energy density, relatively low self-discharge rate, and lack of memory effect, and operate by moving lithium ions between positive and negative electrodes during charge and discharge cycles. During discharge, the positive electrode releases lithium ions while the negative electrode absorbs these ions. An electrolyte facilitates the movement of the ions between the electrodes. A separator is a porous membrane in the battery which separates the electrodes and facilitates the flow of ions. However, various challenges are presented in designing Lithium-ion batteries, including the rapid loss of discharge capacity at lower temperatures.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1A depicts an example Li-Ion battery 100 in a coin cell configuration, in accordance with various embodiments.

FIG. 1B depicts an example Li-Ion battery 150 in a generalized configuration, in accordance with various embodiments.

FIG. 2A depicts scanning electron microscope (SEM) images using secondary and backscattered electron imaging to analyze a silicon electrode, in accordance with various embodiments.

FIG. 2B depicts a chart of particle distribution size for copper particles in a silicon electrode, in accordance with various embodiments.

FIG. 3 depicts an X-ray diffractometer (XRD) pattern of a heat-treated copper-modified silicon electrode prior to cycling, showing the Cu₃Si phase indicated by ticks 300, 301 and 302, and the silicon indicated by ticks 310, 311, 312 and 313, where the remaining peaks are copper due to the current collector, in accordance with various embodiments.

FIG. 4 depicts the average discharge capacity of the silicon electrode in 1.0M lithium bis(fluorosulfonyl)imide salt (LiFSI) in diethyl ether (DEE) and 0.8M Lithium bis(trifluoromethane)sulfonimide (LiTFSI), 0.2M Lithium nitrate (LiNO₃) in 1,3-dioxolane (DOL)/1,2-dimethoxyethane (DME)+Fluoroethylene carbonate (FEC) electrolyte systems at room temperature with 280 mA/g current density, in accordance with various embodiments.

FIG. 5 depicts the average discharge capacity of the silicon electrode in 1.0M LiFSI in DEE and 0.8M LiTFSI, 0.2M LiNO₃ in DOL/DME+FEC electrolyte systems at −20° C. with 200 mA/g current density, in accordance with various embodiments.

FIG. 6 depicts the average discharge capacity of the silicon electrode in 1.0M LiFSI in DEE and 0.8M LiTFSI, 0.2M LiNO₃ in DOL/DME+FEC electrolyte systems at −30° C. with a current density of 200 mA/g, in accordance with various embodiments.

FIG. 7 depicts results of cycle testing of copper-modified silicon electrodes in full cells that underwent various heat treatment (HT) steps, tested for 100 cycles at room temperature and at a 280 mA/g current density, in accordance with various embodiments.

FIG. 8A depicts SEM images of the surfaces of various copper-modified silicon electrodes before heat treatment at 850° C. without vacuum oven, in accordance with various embodiments.

FIG. 8B depicts SEM images of the surfaces of various copper-modified silicon electrodes before heat treatment at 700° C. without vacuum oven, in accordance with various embodiments.

FIG. 8C depicts SEM images of the surfaces of various copper-modified silicon electrodes before heat treatment at 700° C. with vacuum oven first before heat treatment, in accordance with various embodiments.

FIG. 9 depicts a thermal gravimetric analysis (TGA) (plot 1000) and differential scanning calorimetry (DSC) (plot 1010) curves showing various mass loss and phase transformation events in copper-modified silicon electrodes that underwent heat treatment only but not vacuum oven drying, in accordance with various embodiments.

FIG. 10 depicts TGA (plot 1020) and DSC (plot 1030) curves showing various mass loss and phase transformation events in copper-modified silicon electrodes that underwent vacuum oven drying followed by heat treatment, in accordance with various embodiments.

FIG. 11A depicts TGA (plot 1100) and DSC (plot 1110) curves showing Polyvinylidene fluoride (PVDF) binder decomposition and mass loss at approximately 430° C., in accordance with various embodiments.

FIG. 11B provides a comparison between different binder percentages within silicon electrodes and utilizing vacuum oven drying before heat treatment step or not, in accordance with various embodiments.

FIG. 12 depicts an XRD comparing the PVDF binder powder (plot 1200) and the cast film after vacuum oven only (plot 1210), in accordance with various embodiments.

FIG. 13 depicts results of cycle testing of copper-modified silicon electrodes in full cells that underwent various heat treatment steps, tested for 100 cycles at −20° C. and at 200 mA/g current density, in accordance with various embodiments.

FIG. 14A depicts charge capacity curves showing the first and last de-lithiation step (plots 1400 and 1410, respectively) of copper-modified silicon electrodes in full cells at −20° C., with electrodes heat treated at 850° C. with no vacuum oven, in accordance with various embodiments.

FIG. 14B depicts charge capacity curves showing the first and last de-lithiation step (plots 1420 and 1430, respectively) of copper-modified silicon electrodes in full cells at −20° C., with electrodes heat treated at 700° C. with no vacuum oven, in accordance with various embodiments.

FIG. 14C depicts charge capacity curves showing the first and last de-lithiation step (plots 1440 and 1450, respectively) of copper-modified silicon electrodes in full cells at −20° C., with electrodes dried in vacuum oven prior to being heat treated at 700° C., in accordance with various embodiments.

FIG. 15 depicts the effect of heat treatment (HT) on cycle performance for Si—Cu electrodes at room temperature (23° C.), in accordance with various embodiments.

FIG. 16 depicts a plot of battery capacity versus cycle number for Li metal Si—Cu DOL_DME with 250 cycles at −20° C., in accordance with various embodiments.

FIG. 17 depicts a plot of battery capacity versus cycle number at room temperature for copper-modified silicon electrodes heat treated at 700° C. without vacuum oven (squares, plot 1710) and with drying in vacuum oven followed by heat treatment at 700° C. (diamonds, plot 1700), in accordance with various embodiments.

FIG. 18 depicts a plot of battery capacity versus cycle number at −20° C. for copper-modified silicon electrodes heat treated at 700° C. without vacuum oven (squares, plot 1710) and with drying in vacuum oven followed by heat treatment at 700° C. (diamonds, plot 1700), in accordance with various embodiments.

FIG. 19 depicts plots of an average life cycle performance of coin cells that were vacuum oven dried prior to heat treatment at 700° C. in DOL/DME and DEE (diamonds, plots 1910a and 1910b) and DEE (circles, plots 1900a and 1900b) electrolyte, in accordance with various embodiments.

FIG. 20 depicts a plot of battery capacity versus cycle number at −30° C. for cells that soaked for 3 hours (diamonds) vs. 3 days (squares) before initial room temperature formation cycles, both in DOL/DME electrolyte, in accordance with various embodiments.

FIG. 21 depicts a plot of battery capacity versus cycle number at −40° C. for cells that soaked for 3 hours (diamonds) vs. 3 days (squares) before initial room temperature formation cycles, both in DOL/DME electrolyte, in accordance with various embodiments.

FIG. 22 depicts a plot of battery capacity versus cycle number at −30° C. for cells that contain silicon electrodes heat treated at 700° C. including vacuum oven drying (diamonds, plot 2200) and excluding vacuum oven drying (circles, plot 2210), both in DEE electrolyte, in accordance with various embodiments.

FIG. 23 depicts a plot of battery capacity versus cycle number at −40° C. for cells that contain silicon electrodes heat treated at 700° C. including vacuum oven drying (diamonds, plot 2300) and excluding vacuum oven drying (circles, plot 2310), both in DEE electrolyte, in accordance with various embodiments.

### DETAILED DESCRIPTION

As mentioned at the outset, various challenges are encountered in designing Lithium-ion batteries, including the rapid loss of discharge capacity at lower temperatures.

Traditionally used cathodes and anodes in lithium-ion batteries are close to their theoretical capacity limits. Lower temperatures, e.g., below freezing, lead to rapid loss of discharge capacity. The solutions provided herein address the above and other issues.

In one aspect, the solutions herein involve the development of new electrodes that can deliver high capacity at low temperatures. Through the addition of copper to a silicon electrode, a more robust structure is formed, improving discharge capacity at room temperature. This solution combines the optimization of an electrolyte to improve low temperature performance of lithium metal in conjunction with a copper-modified silicon electrode in a coin cell at −20° C. and −30° C. Of two ether-based electrolyte systems used, a lithium salt dissolved in diethyl ether was found to deliver 700 mAh/g discharge capacity after 100 cycles at −20° C. Both electrolyte systems still manage to deliver much higher discharge capacity at −20° C. and −30° C. than traditional carbonate-based electrolytes used with traditional electrodes.

In another aspect, various heat treatments were provided on a copper-modified silicon electrode to improve discharge capacity at low temperatures. An optimized ether-based electrolyte was also used in tandem with lithium metal as anode to create coin cells and test at −20° C. Interestingly, when vacuum drying of the silicon electrode is carried out before heat treatment, cells made from these electrodes show capacity retention of 1250 mAh/g after 100 cycles at −20° C., having already Cycled For 100 Cycles At Room Temperature.

### Part 1—Electrode and Electrolyte Composition

### 1. Introduction

Next generation higher capacity electrodes for use in lithium-ion batteries are highly sought after for today's energy storage needs. For example, with the demand for electric vehicles increasing, along with higher capacity batteries needed for aerospace applications, there is an added challenge to consider before mass production is implemented. Lithium-ion battery discharge capacity greatly diminishes at temperatures below 0° C., retaining only a fraction of its room temperature capacity at −40° C., depending on the electrolyte. It would also benefit electric vehicles used in colder climates and lithium-ion batteries used in satellites, rovers and landers to examine and improve the performance of higher capacity electrodes at low temperature. The most common electrodes considered for this endeavor have been lithium metal (3860 mAh/g) and silicon (4200 mAh/g). Both have over ten times the theoretical capacity of graphite (372 mAh/g), and the lithium metal oxides used (170-274 mAh/g), as traditional anode and cathodes respectively.

The problems so far hindering widespread implementation of both electrodes have been extensively studied, with dendrite formation affecting lithium metal and volume expansion and severe capacity fade affecting silicon-based electrodes. Use of certain solvents has helped improve the performance of lithium metal, particularly at low temperatures; however; research has typically been done pairing lithium to traditional lithium metal oxides. Several generations of silicon electrodes have also been thoroughly investigated to improve general performance at room temperature via the incorporation of nanoparticles, fabrication of nanowires and hollow spheres, and use of silicon carbon composites. While nanorods and composites have showed significant improvement in performance, the fabrication procedure is still time consuming and extensive.

The solutions provided herein can use a facile procedure of incorporating copper additive into the silicon slurry to help initiate a copper silicon phase that can improve silicon performance. The third component, the electrolyte, has seen the most advances in optimization for lithium-ion batteries at low temperatures. Several electrolyte formulations based on carbonates and ethers have been developed to improve low temperature performance in lithium-ion batteries. These too, however, have usually been tested in cells containing traditional electrodes such as lithium metal oxide and graphite. The solutions provided herein combine the optimization of a robust ether-based electrolyte for low temperature testing with lithium metal

and a copper-modified silicon electrode in coin cells to demonstrate the significant improvement in discharge capacity over traditional electrodes at −20° C. and −30° C.

### 2. Materials and Methods

### 2.1 Electrode Preparation

Silicon electrodes were fabricated from batch reactions of dry materials dissolved in an appropriate solvent. Silicon nanoparticles, polyvinylpyrrolidone (PVP), Super C65 (conductive carbon) and anhydrous copper chloride were added in a 21-75-2-2 mass ratio. Super C65 refers to MSE PRO 50 g SUPER C65 Nano Carbon Black Conductive Additive. These components represented the active material (Silicon nanoparticles), binder (PVP), conductive carbon (Super C65) and metal additive (anhydrous copper chloride), respectfully. The mass ratio of the binder is 75% in this example but could be, e.g., 30% or more or 50% or more, or at least 50% of the slurry by mass. The binder can comprise at least 65-75% of the slurry by mass.

The anhydrous copper chloride is added to help with a certain phase formation which will be discussed later. PVP binder was added to N-Methyl-2-pyrrolidone (NMP) solvent first and allowed to completely dissolve before adding the active materials and conductive carbon. The resulting slurry was mixed for 24 hours before being cast at 260 μm onto battery grade copper foil (a current collector), followed by drying in a vacuum oven for 12 hours at 120° C. The drying in the vacuum oven may be at least 12-24 hours at a temperature of at least 100-120° C. The films were then heat treated in a tube furnace at 700° C. for 15 minutes under constant argon flow. The heat treating can be at a temperature of at least 600-700° C. for at least 10-15 minutes. Disks were punched having a diameter of 12.7 mm and average electrode thickness measured to be 20 μm before being transferred into an argon filled glovebox with oxygen and moisture levels below 1.0 ppm (a dry atmosphere). The thickness is reduced from 260 μm to 20 μm due to evaporation of the solvent. This is just the thickness of the silicon electrode and excludes the thickness of the copper current collector. Lithium metal acted as the anode material with a thickness of 750 μm which was also punched into 12.7 mm diameter disks.

### 2.2 Electrolyte Preparation

Two ether electrolyte formulations were prepared in a glove box for low temperature analysis. One ether electrolyte consisted of 1,3-dioxolane (DOL) and 1,2-dimethoxyethane (DME) in a 4:1 by volume ratio, with 10% fluoroethylene carbonate as additive. Lithium bis(trifluoromethane)sulfonimide (LiTFSI) salt and lithium nitrate were added as lithium salts in a 0.8M and 0.2M concentration, respectively and allowed to dissolve for 24 hours in electrolyte before use. The time to dissolve may be at least 12-24 hours. The second electrolyte consisted of 1.0M lithium bis(fluorosulfonyl)imide salt (LiFSI) dissolved in diethyl ether and allowed to dissolve for 24 hours before use. The electrolyte is a liquid solution.

### 2.3 Coin Cell Preparation

Inside an argon filled glovebox, membranes of 25 μm thickness (from Celgard LLC, Charlotte, NC) were soaked in each electrolyte for 15 minutes (e.g., at least about 10-15 minutes) prior to coin cell assembly. The membrane can be soaked in each of the first and second electrolytes for at least about 10-15 minutes. CR 2032 cathode and anode caps, as well as stainless steel spacers and springs were used as purchased. Coin cells were then assembled with each electrolyte being tested in triplicate. All cells were then crimped, labelled and transferred out of the glovebox for cycle testing.

### 2.4 Charge and Discharge Cycle Testing

Cycle testing was performed using a multichannel battery analyzer rated for 5V and 1mA testing conditions. Coin cells were cycled between 0.01V and 1.5V using a constant-current discharge followed by a hybrid constant-current constant-voltage charge profile, at room temperature (23° C.), at −20° C. and at −30° C. For solid electrolyte interphase (SEI) layer formation, two cycles at C/50 were performed prior to normal C/10 testing rate for 20 cycles at room temperature for both electrolyte systems. C/50 refers to a discharge rate where the current drawn is equal to 1/50th of the battery's rated capacity per hour. At this discharge rate, it would take 50 hours to fully deplete the battery. Although generally a slow C-rate, the active material in these coin cells correlates to a current density of 280 mA/g. Once testing completed at room temperature, cells were transferred into an environmental chamber at −20° C. for 100 cycles and a slightly lower charge/discharge rate, resulting in a current density of 200 mA/g. Following testing at −20° C. the cells were lowered to −30° C. to test for another 25 cycles at the same current density.

### 2.5 Characterization

Silicon electrodes were analyzed prior to cycle testing using a FEI Scios 2 Dual Beam Focused ion beam (FIB)/SEM microscope (Thermo Fisher Scientific Inc., Waltham, MA) to inspect surface morphology. A working distance of 7 mm and accelerating voltage of 5kV were used throughout the imaging process. To verify the presence of the Cu₃Si phase, silicon electrodes were investigated using a SmartLab X-ray diffractometer (XRD) (Rigaku Americas Corp., Woodlands, TX) with a scan from 2θ=10° to 100° with a step size of 0.07° and a scan rate of 0.5° min⁻¹. Rigaku PDXL2 analysis software and Joint Committee on Powder Diffraction Standards (JCPDS) cards were used to help evaluate the XRD data.

### 3. Results and Discussion

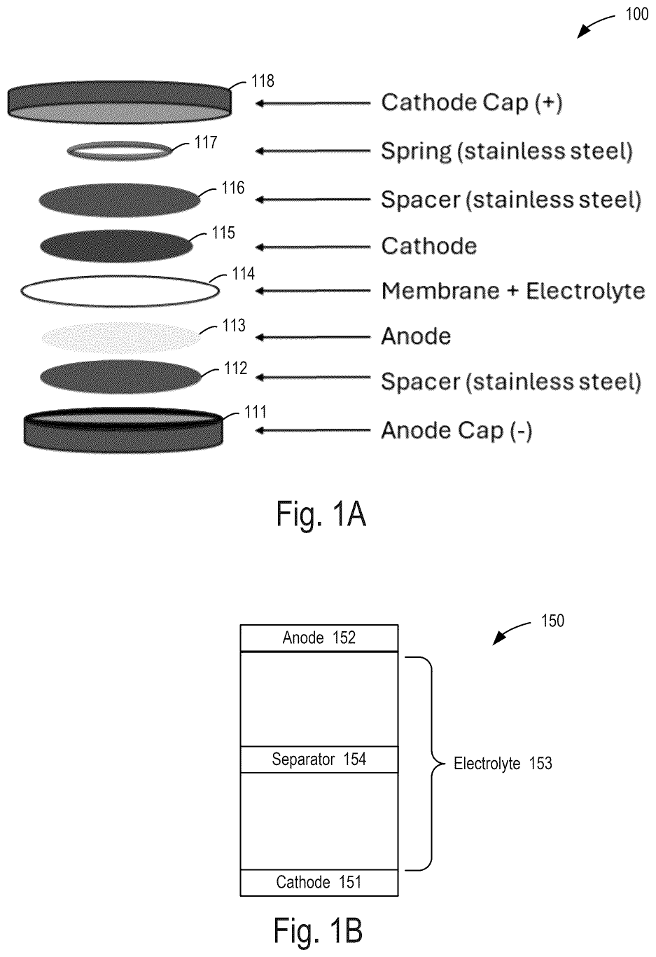

FIG. 1A depicts an example Li-Ion battery 100 in a coin cell configuration, in accordance with various embodiments. The battery is a CR2032 battery having a diameter of 20 mm and a thickness of 3.2 mm. This is a convenient format for experiments but is merely one possible battery as many other formats can be used. The battery includes, from bottom to top, an anode cap 111 (having a negative voltage), a stainless-steel spacer 112, an anode 113, a membrane plus electrolyte 114, a cathode 115, a stainless steel spacer 116, a stainless steel spring 117 and a cathode cap 118 (having a positive voltage).

FIG. 1B depicts an example Li-Ion battery 150 in a generalized configuration, in accordance with various embodiments. The Li-Ion battery 150 includes a cathode 151 at one end of the battery, an anode 152 at an opposing end, an electrolyte solution 153 which extends between the cathode and the anode and a permeable separator 154 between the cathode and anode. The cathode and anode are also referred to as electrodes.

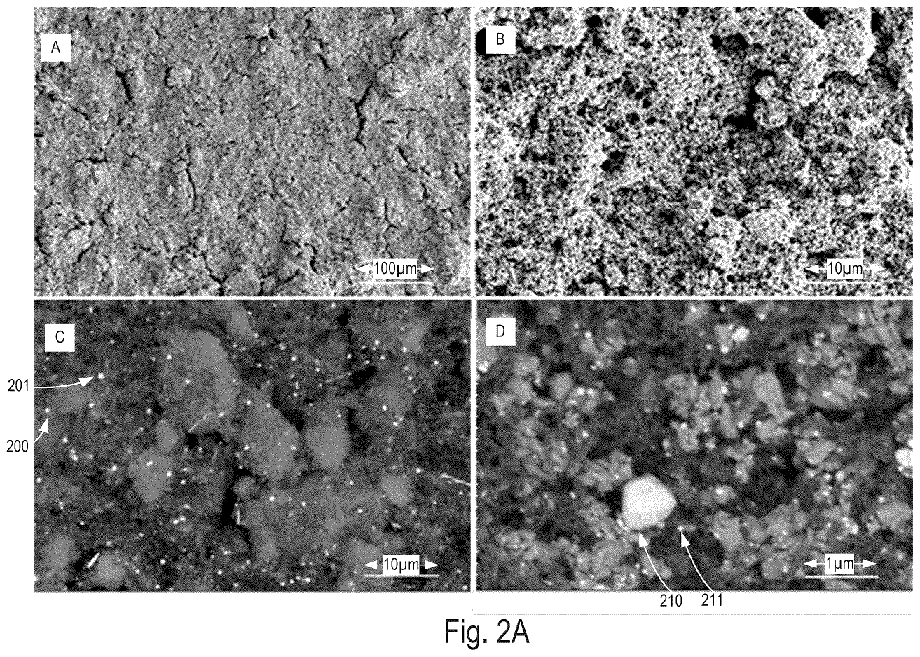

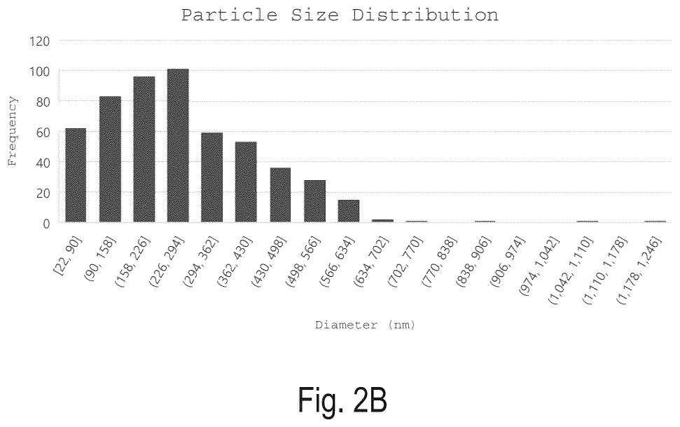

FIG. 2A depicts scanning electron microscope (SEM) images using secondary and backscattered electron imaging to analyze the silicon electrode, in accordance with various embodiments. Surface morphology of the copper-modified silicon electrode prior to cycle testing was observed using SEM. The figure shows the surface of the electrode at different magnifications using both secondary electrons and backscattered electrons to visualize the copper particles.

Image A depicts a secondary electron image showing homogenous particle dispersion across the surface with minor cracking. The scale bar is 100 μm. Image A shows that the electrode is generally homogeneous and has minor cracking throughout.

Image B depicts a secondary image showing a porous network structure. The scale bar is 10 μm. Image B indicates that although there may be some large channels greater than 10 μm, the majority of the surface consists of a highly porous network with channels averaging in size between 1-5 microns with many more even less than 1 micron. This suggests that the electrolyte will have a high efficiency at wetting the entire electrode and be favorable towards facile lithium migration into and out of the electrode.

Image C depicts a backscattered image highlighting the brighter copper particles amongst the silicon and carbon network. The scale bar is 10 μm. Image C is a wide-angle backscattered image highlighting the dispersion of copper particles throughout the material. The even and homogenous distribution of these particles is apparent. The copper particles appear as light specks. For example, see particles 200 and 201.

Image D depicts a backscattered image showing the more abundant copper nanoparticle sizes present. The scale bar is 1 μm. To better understand the size distribution, we see that Image D indicates some copper particles may be as large as 1 micron, but a majority are approximately 100 nm in size, e.g., in a range of about 50 -150 nm. The size can refer to the longest dimension of the particle. For example, the particle 210 is relatively large and the particle 211 is average in size. As mentioned previously, it is the formation of a Cu₃Si phase that improves the silicon electrode performance, so a thorough distribution of nanoscale copper particles will aid in homogenous Cu₃Si phase formation as well. For example, the copper particles can have a size of about 22 nm to about 635 nm. For example, see FIG. 2B. The copper particles increase the conductivity of the electrode. Also, the copper helps prevent cracking and breaking apart of the electrode.

Other metals besides copper could potentially be used, such as silver, gold, platinum, tantalum, titanium, palladium, molybdenum and chromium.

The solutions provided herein change the surface property of the electrodes so that the intercalation of the lithium ion on the electrode is improved. This improves the chemical reaction rate at the electrode surface, at the interface to the electrolyte. Additionally, the resistance of the electrolyte at low temperature is improved. At lower temperatures, the conductivity improvement is due mainly to the electrolyte while at high temperatures, e.g., room temperature, the conductivity improvement is due mainly to the electrode composition.

FIG. 2B depicts a chart of particle distribution size for copper particles in a silicon electrode, in accordance with various embodiments. The horizontal axis depicts different ranges of particle diameters and the vertical axis depicts a frequency with which the range is observed. The most common size is about 226 nm. The size for the majority of the particles may be about 22 nm to about 227 nm, or, more particularly, about 20 nm to about 250 nm, for example.

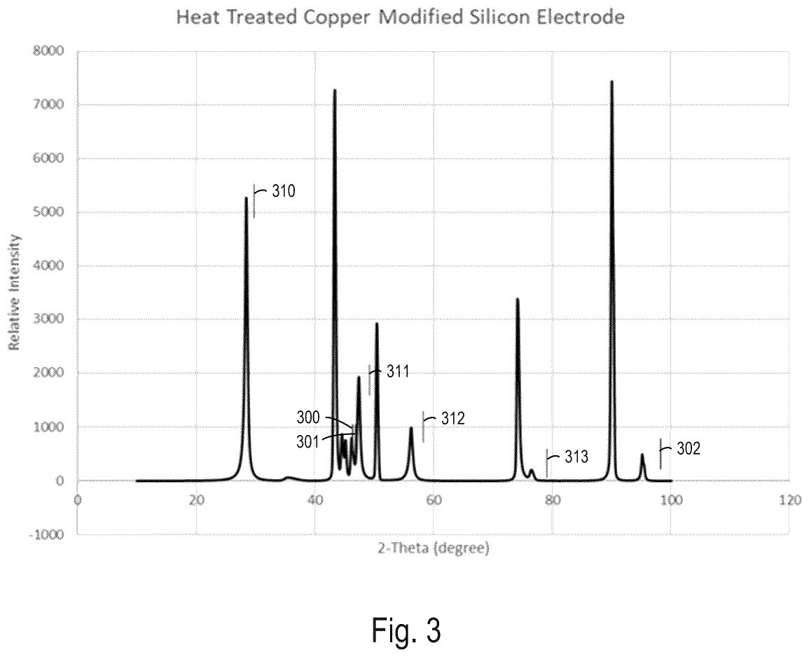

FIG. 3 depicts an X-ray diffractometer (XRD) pattern of a heat-treated copper-modified silicon electrode prior to cycling, showing the Cu₃Si phase indicated by ticks 300, 301 and 302, and the silicon indicated by ticks 310, 311, 312 and 313, where the remaining peaks are copper due to the current collector, in accordance with various embodiments. The figure depicts plots of relative intensity verses θ in degrees. FIG. 3 shows the XRD pattern of this silicon electrode indicating the Cu₃Si phase at 2θ of 44.5° along with a few other peaks as noted, according to JCPD indexes.

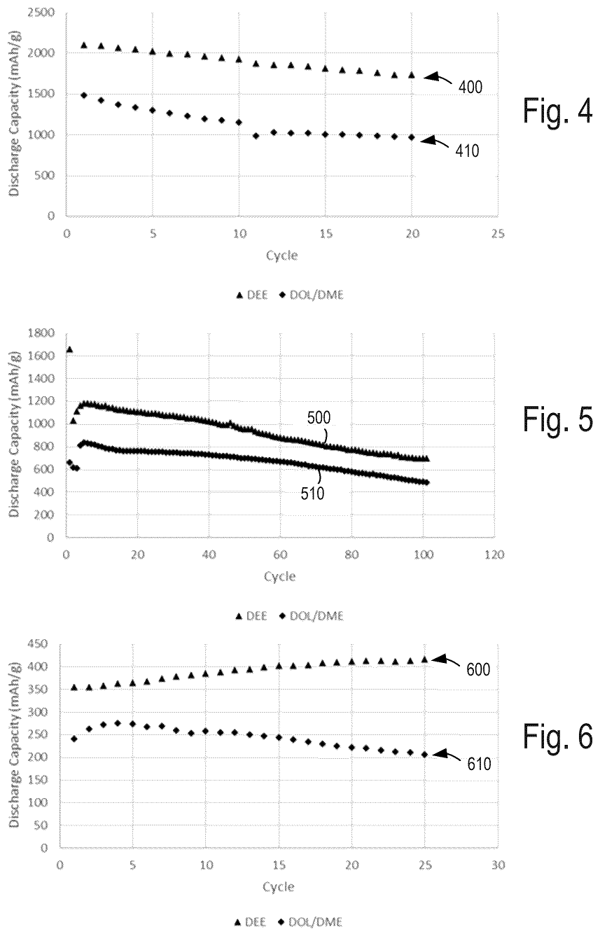

FIG. 4 depicts the average discharge capacity of the silicon electrode in 1.0M lithium bis(fluorosulfonyl)imide salt (LiFSI) in diethyl ether (DEE) and 0.8M Lithium bis(trifluoromethane)sulfonimide (LiTFSI), 0.2M Lithium nitrate (LiNO₃) in 1,3-dioxolane (DOL)/1,2-dimethoxyethane (DME)+Fluoroethylene carbonate (FEC) electrolyte systems at room temperature with 280 mA/g current density, in accordance with various embodiments. The figure depicts plots of discharge capacity in mAh/g verses cycles.

FIG. 4 demonstrates the average discharge capacity of the silicon electrode at room temperature for both the DEE and DOL/DME electrolyte-based cells, omitting the two formation cycles. After 20 cycles, an average of 1000 mAh/g is recorded at a 280 mA/g current density for the DOL/DME based electrolyte (diamonds, plot 410). After 20 cycles an average of approximately 1700 mAh/g is recorded at 280 mA/g current density for the DEE based electrolyte (triangles, plot 400), showing significantly higher capacity than the DOL/DME electrolyte-based cells. It should be noted that both electrolyte formulations deliver higher discharge capacities than if the same electrodes were used with traditional carbonate-based electrolyte. This is due to the greater stability imparted to the lithium metal from the ether than a carbonate-based system.

FIG. 5 depicts the average discharge capacity of the silicon electrode in 1.0M LiFSI in DEE and 0.8M LiTFSI, 0.2M LiNO₃ in DOL/DME+FEC electrolyte systems at −20° C. with 200 mA/g current density, in accordance with various embodiments. The figure shows the average discharge capacity of the silicon electrode for the DOL/DME based electrolyte cells (diamonds, plot 510) for 100 cycles at −20° C. at a 200 mA/g current density. On average, a discharge capacity of approximately 480 mAh/g is retained after 100 cycles at −20° C., which would normally be 2-3 fold higher than traditional graphite electrodes at the same temperature and cycle life. FIG. 4 also shows the average discharge capacity of the silicon electrode for the DEE based electrolyte cells (plot 500) for 100 cycles at −20° C. at a 200 mA/g current density. On average, a discharge capacity of approximately 670 mAh/g is retained after 100 cycles at −20° C. being 3-4 times greater than traditional graphite. When traditional electrodes such as lithium nickel cobalt aluminum oxide (NCA), lithium titanate (LTO), lithium cobalt oxide (LCO) and graphite are utilized with traditional carbonate-based electrolytes, capacities average barely 150 mAh/g for several dozens of cycles at −20° C. Even a copper-modified zinc electrode paired with graphite only maintains 200 mAh/g at −20° C. for a few 30 cycles. Both sets of cells were then lowered to −30° C. and tested for 25 cycles each at 200 mA/g current density.

FIG. 6 depicts the average discharge capacity of the silicon electrode in 1.0M LiFSI in DEE and 0.8M LiTFSI, 0.2M LiNO₃ in DOL/DME+FEC electrolyte systems at −30° C. with a current density of 200 mA/g, in accordance with various embodiments. The figure shows the average discharge capacity for both sets of cells indicating a significant decline in capacity retention for the DOL/DME electrolyte system (plot 610), retaining just over 200 mAh/g. However, the DEE electrolyte system (plot 600) actually shows an increase in discharge capacity as cycling continues, reaching an average of just over 400 mAh/g after 25 cycles. Both electrolyte designs show improved performance towards a lithium-silicon cell design at −20° C., with the DEE electrolyte system demonstrating superior discharge behavior at both −20° C. and −30° C. While cycle life requirements for electric vehicles are typically on the order of maintaining approximately 80% initial capacity for several thousand cycles, National Aeronautics and Space Administration (NASA) requirements for Martian rovers are more on the order of only a couple hundred cycles. This chemistry demonstrates the ideal requirements for next generation electrodes that can deliver much higher capacities at low temperatures which will undoubtedly aid in future Mars missions and other aerospace applications. Many other applications are possible as well.

### 4. Conclusion

There has been thorough investigation over the last two decades into various ways to improve silicon performance in general at room temperature, albeit with complex electrode fabrication techniques. There has also been large success from these investigations, with some silicon electrodes able to deliver approximately 2000 mAh/g for hundreds of cycles, however, there has been little investigation into silicon's performance at low temperatures. Lithium metal has received more investigation into low temperature performance and the electrolytes that allow for improved performance, but usually as a half-cell or paired with other lithium metal oxide cathodes. So, while there has been significant research to improve the low temperature testing of lithium metal and of the silicon electrode at room temperature, there have been no studies that show the combined optimization of both utilizing a robust electrolyte design for full cell low temperature testing. The solutions provided herein highlight the combined optimization of a low temperature electrolyte towards an easily fabricated, copper-modified silicon electrode paired with lithium metal, demonstrating one of the highest discharge capacities of a silicon electrode at low temperatures reported to our knowledge to date. While many different silicon electrode designs could be used to investigate low temperature performance of the anode, this facile modification technique along with insight from these electrolyte systems could help further guide research towards the kind of multi-faceted optimization needed to allow for even greater discharge capacity at low temperatures.

### Part 2—Heat Treatment of Electrodes

### 1. Introduction

With major growth in renewable energy production and a call for greater energy storage capacity, from grid level, to electric vehicles (EVs) and personal electronics, demand for electrochemical energy storage is rapidly increasing. Even though there are traditionally separate battery technologies for grid level storage and EVs, the ability to transfer energy amongst applications and create one homogenous energy system is expanding. The opportunity for electric vehicles to contribute to grid level energy storage is now becoming more feasible, and the lithium-ion batteries utilized in electric vehicles will need higher performance standards for this endeavor. While the drive to decarbonize the automotive industry, along with range anxiety, are major forces in pursuing higher capacity batteries for electric vehicles, other industries such as aerospace and space exploration would benefit as well. Satellites, landers and Martian rovers all utilize lithium-ion batteries, and as their energy demands increase over the years, so does the need for battery chemistry that can deliver higher energy density. An added challenge to lithium-ion batteries employed in the aerospace industry and electric vehicles in colder climates, is that of maintaining high energy density at lower temperatures, as lithium-ion cells decrease in performance below ambient temperature. The growth and demand in these industries requires next generation lithium-ion chemistry that not only delivers significantly higher energy density, but also has inherently robust features capable of maintaining excellent

performance at temperatures below 0° C. Silicon, which has a theoretical capacity of 4200 mAh/g, and lithium metal which has a theoretical capacity of 3860 mAh/g, are prime candidate materials for this next generation lithium-ion chemistry.

Indeed, silicon and lithium metal both have over ten times the theoretical capacity of the graphite anode (372 mAh/g) that is used in traditional lithium-ion cells today, however both suffer from physical attributes that hinder commercialization even after decades of research. The barriers that plague these electrodes at ambient temperatures are only exacerbated at low temperatures below 0° C. First, upon lithiation, silicon expands in volume nearly 300%. This disrupts the structural integrity, diminishes conductive pathways for electrons throughout the electrode, and constantly cracks and reforms the solid electrolyte interface (SEI). The solution to allow adequate capacity retention for the silicon electrode even at room temperature is multi-faceted, including reducing volume expansion and cracking, increasing conductivity, and altering SEI properties to allow the least resistance to lithiation and de-lithiation. There has been considerable research as to which is the most resistive and rate limiting process during discharge of a lithium-ion battery at low temperatures, with more recent literature highlighting the importance of lithium-ion solvation and desolvation from electrode interfaces, over bulk electrolyte conductivity or SEI resistance.

To address the issues lithium metal electrodes have faced at low temperatures, using ether-based solvents greatly improve performance over carbonate-based ones. A high degree of fluorination in the electrolyte also improves performance. For example, using methyl 3,3,3-trifluoroprpionate mixed with fluoroethylene carbonate yields high capacity retention in a lithium metal/NMC cell from −40° C. to −60° C. There have been several helpful advances in improving silicon electrode performance over the years, namely using silicon nanoparticles, utilizing transition metal additives and forming a fluorine rich SEI layer. The choice of binder also cannot be neglected in it's influence on silicon electrode behavior. For example, carboxy methylcellulose (CMC) and polyacrylic acid (PAA) are two favorable binders to use in silicon electrodes.

Polyvinylidene fluoride has typically been regarded as a poor binder to use in silicon electrodes, and binder amounts are usually kept low in regard to dry mass ratio to other components. Drying steps also usually just include vacuum oven drying or heat treatment, instead of both. However, through the combination of vacuum oven drying and heat treatment

steps to form the Cu₃Si phase, the solutions provided herein demonstrate that the use of PVDF as a binder in high concentrations can be beneficial towards silicon electrode capacities both at room temperature and low temperature. The binder, through degradation at high temperatures, is likely forming a Si—C/Cu composite and enhancing performance. Through the optimization of silicon electrode properties, and optimization of electrolyte for use in conjunction with lithium metal and at low temperatures, coin cells are made and display high discharge capacity through 100 cycles at room temperature and 100 cycles at −20° C. To the best of our knowledge, this is the highest discharge capacity seen at −20° C. for this many cycles and for the current density tested at.

### 2. Materials and Methods

### 2.1 Electrode Preparation

Silicon electrodes were created from batch reactions of dry powders dissolved in N-Methyl-2-pyrrolidone (NMP) solvent. Active reagents were silicon nanoparticles and anhydrous copper chloride, while Super C65 was used as a conductive additive and a binder was polyvinylidene fluoride (PVDF). The mass ratio of each component was dissolved to be 21-2-2-75 for active material (silicon nanoparticles), metal reagent, conductive carbon (Super 65) and binder, respectively. Binder is added first to the solvent as it takes the longest to dissolve, before adding the active materials and conductive carbon. The resulting slurry was then mixed for 24 hours before being cast at 260 μm onto battery grade copper foil, followed by drying in a vacuum oven for 12 hours at 120° C. The thin films were then heat treated in a tube furnace at 700° C. for 15 minutes at a ramp rate of 4° per minute. Alternatively, certain films excluded drying in the vacuum oven and instead were allowed to dry in the fume hood for two hours followed immediately by heat treatment either at 700° C. for 15 minutes at a ramp rate of 4° per minute or at 850° C. for 15 minutes at a ramp rate of 10° per minute, all under constant argon flow. The heat treating may be at a temperature of at least 700° C. for at least 10-15 minutes. Disks were then punched having a diameter of 12.7 mm and an average electrode thickness of 20 μm. All electrodes were then transferred into an argon filled glovebox with oxygen and moisture levels below 1.0 ppm. Lithium metal functioned as the anode material with a thickness of 750 μm which was also punched into 12.7 mm diameter disks inside the glovebox.

### 2.2 Electrolyte Preparation

An ether-based electrolyte was prepared in a glove box for improved low temperature performance. 1,3-dioxolane (DOL) and 1,2-dimethoxyethane (DME) were mixed in a 4:1 by volume ratio, with 10% fluoroethylene carbonate used as additive. Lithium bis(trifluoromethane)sulfonimide (LiTFSI) salt and lithium nitrate were added to the solvents at 0.8M and 0.2M concentrations, respectively, and allowed to dissolve for 24 hours before use.

### 2.3 Coin Cell Preparation

Celgard membranes (e.g., separator) of 25 μm thickness were soaked in DOL/DME electrolyte for 15 minutes inside an argon filled glovebox preceding coin cell assembly. CR 2032 cathode and anode caps, as well as stainless steel spacers and springs were used as purchased. Coin cells were then assembled in triplicate, crimped, labelled, and transferred out of the glovebox for cycle testing.

### 2.4 Charge and Discharge Cycle Testing

Cycle testing was conducted using a multichannel battery analyzer rated for 5V and 1 mA testing conditions. Coin cells were cycled between 0.01V and 1.5V using a constant current discharge followed by a hybrid constant-current constant-voltage charge profile, at room temperature and at −20° C. To allow for durable SEI formation, two cycles at a slow C/50 were executed prior to normal C/10 testing rate for 100 cycles at room temperature. Once testing completed at room temperature, cells were transferred into an environmental chamber at −20° C. for a subsequent 100 cycles at the same charge and discharge rate as at room temperature.

### 2.5 Characterization

Melting and phase change behavior of the silicon slurry and pure binder were analyzed using thermal gravimetric analysis (TGA) and differential scanning calorimetry DSC on a Netzsch STA 449 F3 Jupiter® Simultaneous Thermal Analyzer (Netzsch Group, Selb, Bayern, Germany). Aluminum pans were utilized for measurement and samples were run under Argon inert atmosphere. Temperature ranges and ramp rates mimicked the previously mentioned heat treatment settings in order to gain an understanding of phase behavior of each component at different temperatures. To verify the presence of the Cu₃Si phase, silicon electrodes were investigated using a SmartLab X-ray diffractometer (XRD) with a scan from 2θ=10° to 100° with a step size of 0.07° and a scan rate of 0.5° min⁻¹. Rigaku PDXL2 analysis software and JCPDS cards were used to help evaluate the XRD data. Silicon electrodes were also analyzed prior to cycle testing using a FEI Scios 2 Dual Beam FIB/SEM microscope to inspect surface

morphology. A working distance of 7 mm and accelerating voltage of 5 kV were used throughout the imaging process.

### 3. Results and Discussion

As mentioned previously, the formation of a Cu₃Si phase through heat treatment at 700° C. is central to increased discharge capacity. With any lithium-ion electrode preparation, drying of the electrode is paramount to better performance and cycle life, so examining different combinations of drying and heat treatment steps could offer increased discharge capacity not just at room temperature, but at low temperatures as well. Drying electrodes in a vacuum oven at mild temperatures (120° C.) for several hours is very common, and heat treatment of electrodes is less common, but still performed with certain chemistries and when certain structural effects are desired. Heat treatment may also refer to raising temperatures only to 300° C. or 400° C., a temperature just at the edge of binder decomposition. Both steps of drying in a vacuum oven followed by heat treatment are usually not carried out together as the electrode typically undergoes one or the other. Here, we tested silicon electrodes in full cells that excluded the vacuum oven and only underwent heat treatment at two different temperatures and ramp rates, and we tested silicon electrodes that were dried in a vacuum oven followed by heat treatment.

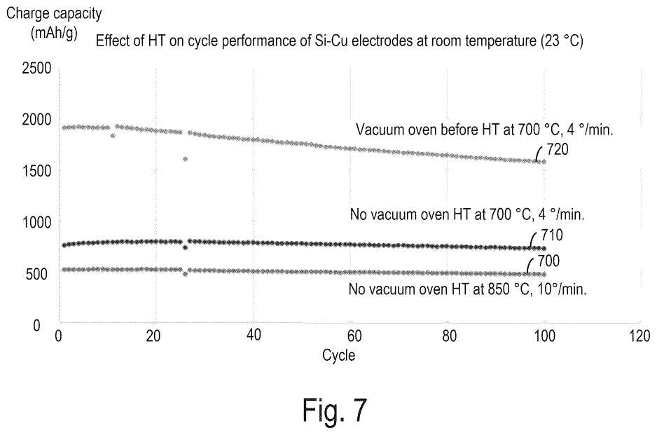

FIG. 7 depicts results of cycle testing of copper-modified silicon electrodes in full cells that underwent various heat treatment (HT) steps, tested for 100 cycles at room temperature and at a 280 mA/g current density, in accordance with various embodiments. Silicon electrodes are heat treated at 850° C. without vacuum oven (plot 700), heat treated at 700° C. without vacuum oven (plot 710) and with vacuum oven followed by heat treatment at 700° C. (plot 720).

This figure shows the discharge capacities of silicon electrodes in full cells that underwent these 3 heat treatment conditions. Plot 700 represent electrodes that omitted vacuum oven drying and only experienced heat treatment at 850° C. for 15 minutes at a ramp rate of 10 degrees per minute. Plot 710 represent electrodes that omitted vacuum oven drying and experienced heat treatment at 700° C. for 15 minutes at a ramp rate of 4 degrees per minute, and plot 720 represent electrodes that were placed in the vacuum oven to dry and were then subsequently heat treated at 700° C. for 15 minutes at a ramp rate of 4 degrees per minute. It is easy to see that the electrodes heat treated at 850° C. cycled at the lowest discharge capacity retaining on average only about 500 mAh/g after 100 cycles. The electrodes that excluded vacuum oven drying and that were heat treated to 700° C. showed more moderate discharge

capacity retaining on average 750 mAh/g after 100 cycles. Lastly, electrodes that included vacuum oven drying followed by heat treatment at 700° C. showed significantly higher capacity retention, preserving just over 1500 mAh/g after 100 cycles at room temperature, albeit with a higher capacity fade as well.

To understand the discrepancy in cycle testing, the various heat-treated electrodes were examined prior to coin cell fabrication using SEM.

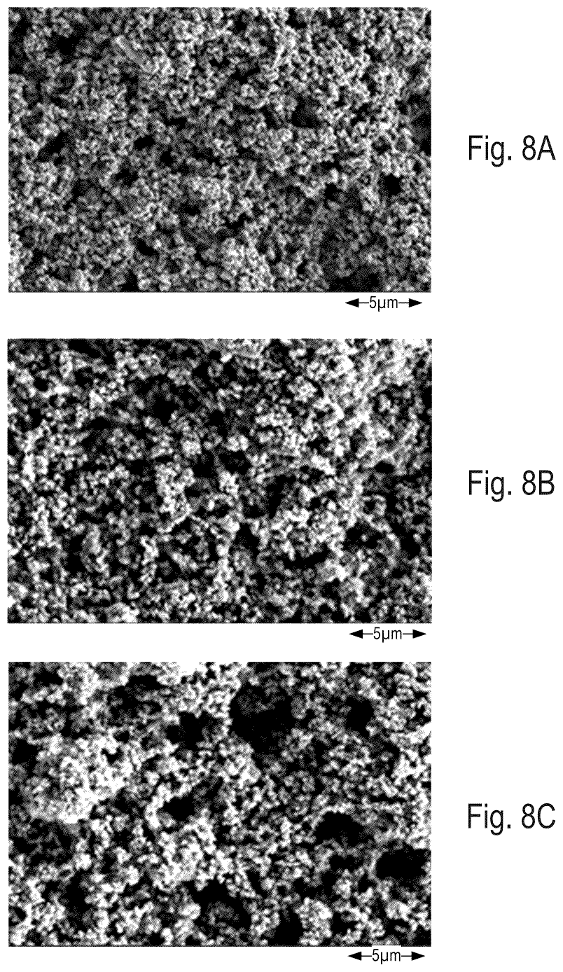

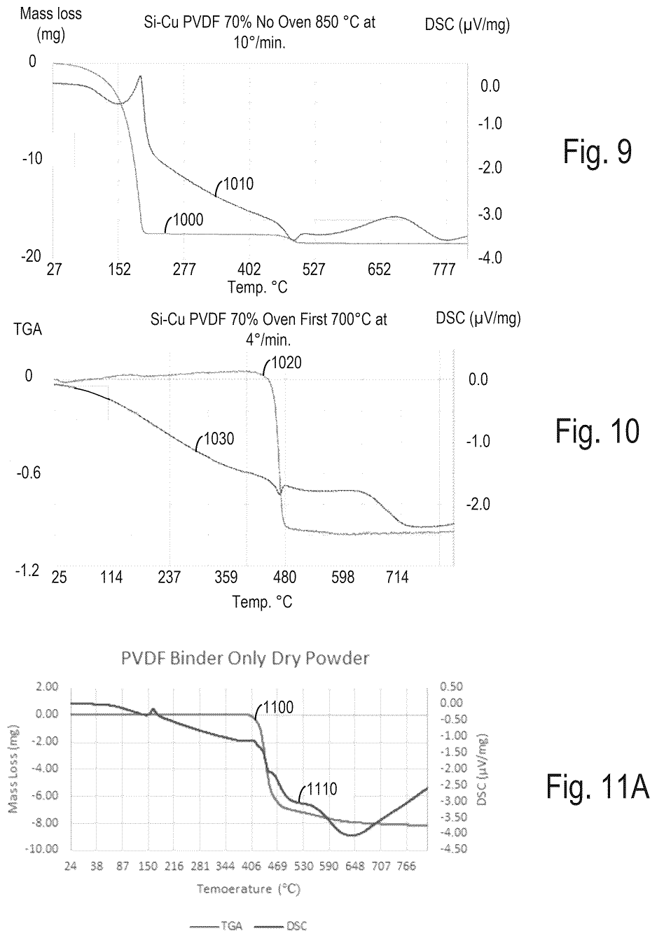

FIG. 8A depicts SEM images of the surfaces of various copper-modified silicon electrodes before heat treatment at 850° C. without vacuum oven, in accordance with various embodiments. This figure shows the surface of a silicon electrode heat treated at 850° C. A scale bar of 5 μm is depicted in FIGS. 8A-8C.

FIG. 8B depicts SEM images of the surfaces of various copper-modified silicon electrodes before heat treatment at 700° C. without vacuum oven, in accordance with various embodiments. This figure shows a silicon electrode excluding vacuum oven drying and heat treated at 700° C.

FIG. 8C depicts SEM images of the surfaces of various copper-modified silicon electrodes before heat treatment at 700° C. with vacuum oven first before heat treatment, in accordance with various embodiments. This figure shows a silicon electrode that underwent vacuum oven drying prior to heat treatment at 700° C.

In FIG. 8A-C, pore size can be seen to decrease when vacuum oven drying is omitted and at higher heat treatment temperatures. Specifically, it is noticeable that the surface of the electrode that underwent vacuum oven drying first has significantly larger pore sizes than the surface of either electrodes that excluded vacuum oven drying. The pore size seems to continue to decrease when the electrode is heat-treated to 850° C. These results could explain some of the discrepancy of the cycle testing results at room temperature. With larger pore size, more electrolyte can penetrate the electrode and allow for more lithium interaction. This could also explain why the electrode with larger pore size exhibits higher capacity fade, manifesting the usual problem with silicon electrodes of electrode degradation due to volume expansion, when more of the electrode is in contact with the electrolyte.

If pore size is decreasing when vacuum oven drying is excluded, increasing wetting time of the electrode before initial formation cycles should help to increase performance.

FIG. 9 depicts a thermal gravimetric analysis (TGA) (plot 1000) and differential scanning calorimetry (DSC) (plot 1010) curves showing various mass loss and phase transformation events in copper-modified silicon electrodes that underwent heat treatment only but not vacuum oven drying, in accordance with various embodiments. The figure shows the TGA (plot 1000) and DSC (plot 1010) curves of the silicon slurry when the sample only undergoes heat treatment.

FIG. 10 depicts TGA (plot 1020) and DSC (plot 1030) curves showing various mass loss and phase transformation events in copper-modified silicon electrodes that underwent vacuum oven drying followed by heat treatment, in accordance with various embodiments. The figure shows the TGA (plot 1020) and DSC (plot 1030) curves of the silicon slurry after the sample has been dried in the vacuum oven and then put through the heat treatment conditions. The sample that undergoes heat treatment conditions immediately shows a large mass loss event attributed to solvent loss with a second, smaller mass loss event at approximately 480° C. due to the partial carbonization or decomposition of the binder. The DSC curve also depicts peaks corresponding to phase changes with the aforementioned mass loss events. The broad DSC curve around 680° C. could be associated with the formation of the Cu₃Si phase. The sample that is subjected to vacuum oven drying prior to heat treatment does not show solvent mass loss, and instead only shows the mass loss and phase change associated with carbonization of the binder, again at approximately 480° C. There is not, however, as distinct a DSC peak indicating formation of the Cu₃Si phase as compared to the sample that immediately underwent heat treatment.

Even though the binder decomposes at such high heat treatment temperatures, there is the possibility an effect of the binder's decomposition influences pore size of the electrode and eclipses the influence of the Cu₃Si phase.

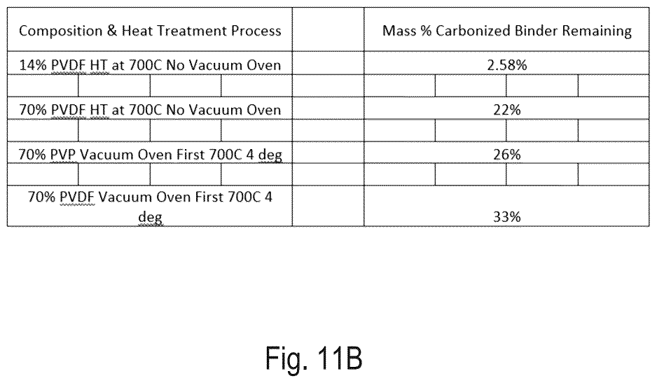

FIG. 11A depicts TGA (plot 1100) and DSC (plot 1110) curves showing Polyvinylidene fluoride (PVDF) binder decomposition and mass loss at approximately 430° C., in accordance with various embodiments. This figure shows the TGA and DSC curves of the PVDF binder in dry powder form, showing melting of the binder in the DSC curve at around 160° C. and decomposition of the binder at approximately 430° C.

FIG. 11B provides a comparison between different binder percentages within silicon electrodes and utilizing vacuum oven drying before heat treatment step or not, in

accordance with various embodiments. The table shows the percent binder remaining in carbonized form after heat treatment for a sample that was subjected to heat treatment only (22%) and a sample that was vacuum dried and heat treated, retaining 33% binder mass. This shows that when binder amounts are used at typical percentages, (10% to 15%) the residual carbonized mass is very minimal. The carbonized mass of a PVP based silicon electrode is noted in the table as well. This also shows that when binder percentages are high, the remainder of binder after decomposition is not negligible and may still impart some influence towards electrode morphology and through extension, discharge capacity in a full cell.

Thus, when binder percentages are higher, the residual mass after heat treatment and binder decomposition is no longer negligible, and that when the vacuum oven is used as a drying step first, even more carbonized binder mass is retained after heat treatment.

The XRD demonstrating the formation of the Cu₃Si phase is shown in FIG. 3, with the phases corresponding to Cu₃Si marked with red ticks and the phases corresponding to silicon marked with blue ticks. XRD was also utilized at different stages of drying and heat treatment to try to understand how the binder changes through each step.

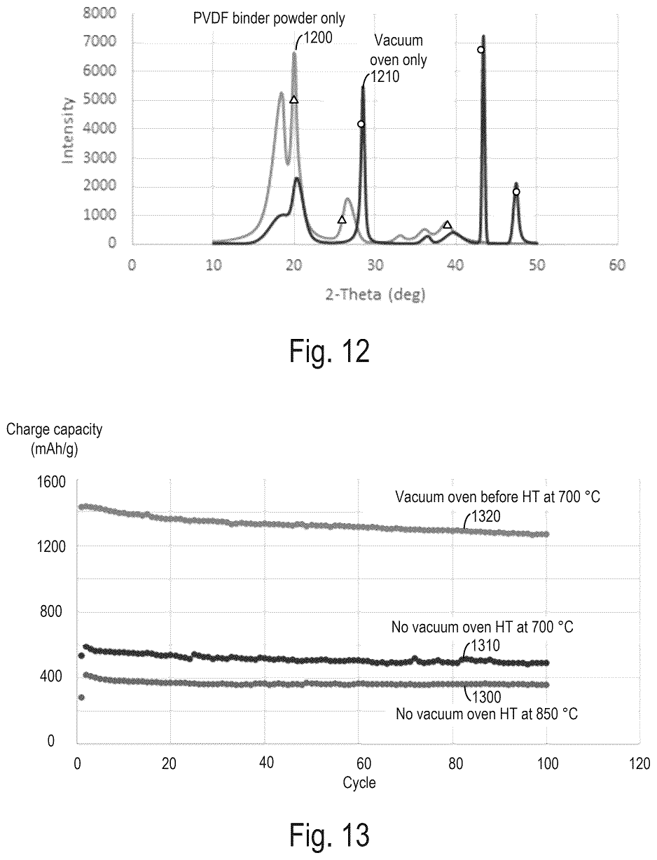

FIG. 12 depicts an XRD comparing the PVDF binder powder (plot 1200, triangles) and the cast film after vacuum oven only (plot 1210, circles), in accordance with various embodiments. This figure shows the XRD of just the binder powder (plot 1200), with two distinct peaks at 18° C. and 20° C. representing two different geometric configurations of the PVDF binder, the alpha and beta forms, respectively. Through vacuum oven drying, the binder has not decomposed yet so may take on different configurations. The XRD of a copper-modified silicon electrode is also shown (plot 1210), showing a shift in the geometric configurations of the binder to favor the beta phase much more over the alpha phase. This indicates that vacuum oven drying could change the configuration of binder from an equal mixture of phases to prefer one geometry over the other.

FIG. 13 depicts results of cycle testing of copper-modified silicon electrodes in full cells that underwent various heat treatment steps, tested for 100 cycles at −20° C. and at 200 mA/g current density, in accordance with various embodiments. This figure FIG. 13 depicts silicon electrodes heat treated at 850° C. without vacuum oven (plot 1300), heat treated at 700° C. without vacuum oven (plot 1310), and with vacuum oven followed by heat treatment at 700° C. (plot 1320).

Lastly, the cycle data at low temperature for cells containing lithium metal and copper-modified silicon electrodes in DOL/DME electrolyte at various drying and heat treatment steps is presented in this figure. The trend we see with various drying steps at room temperature remains the same at −20° C. Silicon electrodes heat treated at 850° C., excluding vacuum oven drying, delivered the lowest discharge capacity after 100 cycles at around 300 mAh/g, followed by electrodes heat treated at 750° C. excluding vacuum oven drying delivering approximately 500 mAh/g, after 100 cycles. Surprisingly, the cells containing silicon electrodes that included vacuum oven drying before heat treating at 750° C. retained an impressive average of 1250 mAh/g after 100 cycles at −20° C., indicating stable SEI on both lithium metal and silicon electrode surfaces, as well as favorable lithium solvation energies in the DOL/DME electrolyte. All cells were tested with 200 mA/g current density.

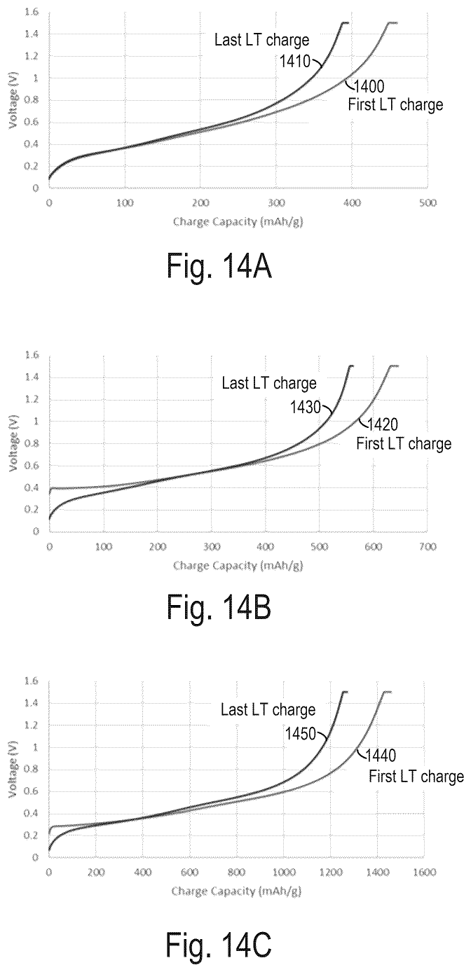

FIG. 14A depicts charge capacity curves showing the first and last de-lithiation step (plots 1400 and 1410, respectively) of copper-modified silicon electrodes in full cells at −20° C., with electrodes heat treated at 850° C. with no vacuum oven, in accordance with various embodiments. This figure compares charge curves of the silicon electrodes heat treated at 850° C., excluding vacuum oven drying from first low temperature charge to last low temperature (LT) charge.

FIG. 14B depicts charge capacity curves showing the first and last de-lithiation step (plots 1420 and 1430, respectively) of copper-modified silicon electrodes in full cells at −20° C., with electrodes heat treated at 700° C. with no vacuum oven, in accordance with various embodiments. This figure shows a similar comparison as FIG. 14A but for electrodes heat treated at 750° C., excluding vacuum oven.

FIG. 14C depicts charge capacity curves showing the first and last de-lithiation step (plots 1440 and 1450, respectively) of copper-modified silicon electrodes in full cells at −20° C., with electrodes dried in vacuum oven prior to being heat treated at 700° C., in accordance with various embodiments. This figure shows the charge curves of electrodes dried in vacuum oven followed by heat treatment at 750° C. We see in a different way, that although the capacity fade for electrodes heat treated at 850° C. and 700° C. without vacuum oven is less, their overall capacity is still exceptionally lower than electrodes that were subjected to vacuum oven drying, demonstrating the superior performance of the latter.

FIG. 14A-C show that amongst the various heat-treated methods, electrodes heat treated at 850° C. only lose about 50 mAh/g of capacity over 100 cycles, and electrodes heat treated at 700° C. only lose about 100 mAh/g of capacity. Electrodes that were vacuum oven dried first before heat treatment lose about 200 mAh/g of capacity, but while exhibiting much higher capacity at low temperatures.

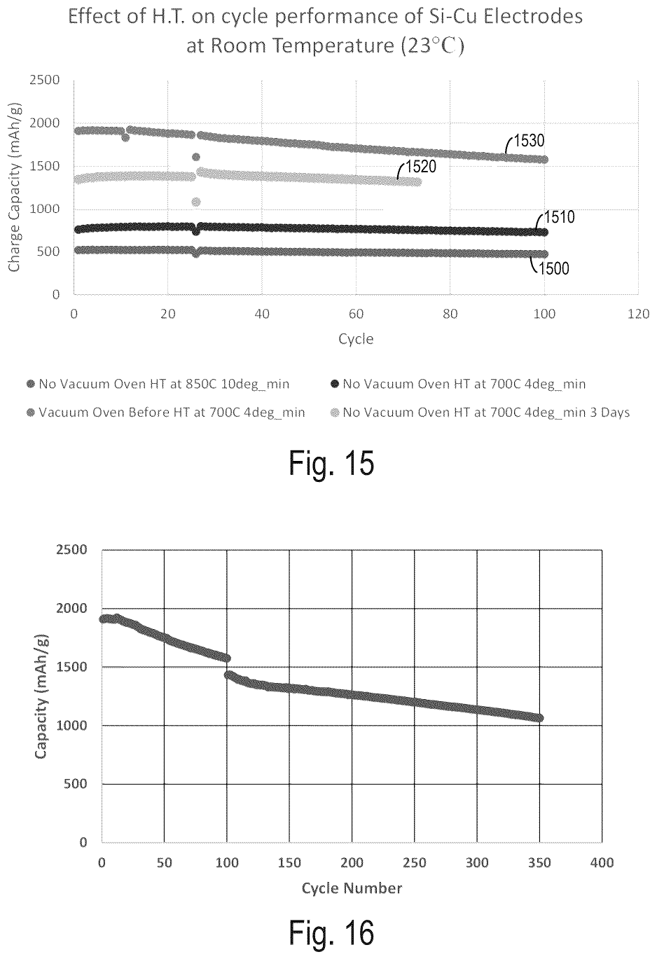

FIG. 15 depicts the effect of heat treatment (HT) on cycle performance for Si—Cu electrodes at room temperature (23° C.), in accordance with various embodiments. The plot 1500 depicts the case of no vacuum oven HT at 850° C. at a rate of 10°/min. The plot 1510 depicts the case of no vacuum oven HT at 700° C. at a rate of 4°/min. The plot 1520 depicts the case of no vacuum oven HT at 700° C. at a rate of 4°/min after three days. The plot 1530 depicts the case of vacuum oven before HT at 700° C. at a rate of 4°/min. The purpose of this graph is to illustrate that increasing wetting time alone (3 Days (plot 1520) vs. 3 Hrs (plot 1510)) is not enough to increase performance to the level of cells made from electrodes that included the vacuum oven drying before the heat treatment step (plot 1530).

The figure shows a major increase in charge capacity but not enough to approach the charge capacity of cells that included vacuum oven drying preceding heat treatment.

This figure shows cycle testing of silicon electrodes that excluded vacuum oven drying and were heat treated at 700° C. but with electrolyte allowed to wet the electrode for 3 days before formation cycles, as opposed to 3 hours in the previous set of cells. It is clear that letting the electrode wet for a longer time is significantly beneficial towards discharge capacity (1300 mAh/g vs. 750 mAh/g). However, it is not enough to match or approach the discharge capacity of the silicon electrodes that included vacuum oven drying before heat treatment. The effect of the Cu₃Si phase formation should impart greater conductivity and stability to the electrode, which is forming regardless of if vacuum oven drying is included or not. If Cu₃Si phase formation, nor electrode wettability are reasons for significant increased performance of electrodes when vacuum oven drying is included, some effect of the polymer binder may be attributing to the cycle results provided.

FIG. 16 depicts a plot of battery capacity versus cycle number for Li metal Si—Cu DOL_DME with 100 cycles at room temperature followed by 250 cycles at −20° C., in accordance with various embodiments. This data at cycles 100-350 show the silicon cells with PVDF binder continuing for an entire 250 cycles at −20° C. The initial 100 cycles are room temperature results. Changing the binder from PVP to PVDF greatly improves performance of the cell at −20 C continuing for an entire 250 cycles at −20 C while maintaining over 1000 mAh/g.

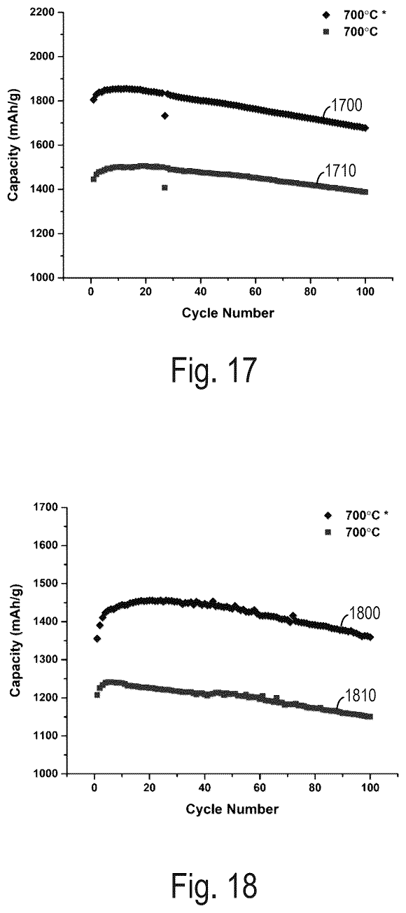

FIG. 17 depicts a plot of battery capacity versus cycle number at room temperature for copper-modified silicon electrodes heat treated at 700° C. without vacuum oven (squares, plot 1710) and with drying in vacuum oven followed by heat treatment at 700° C. (diamonds, plot 1700), in accordance with various embodiments. The cycle testing is for copper-modified silicon electrodes that underwent various heat treatment steps. Cells were tested for 100 cycles at room temperature and at a 420 mA/g current density in DEE electrolyte. Silicon electrodes were heat treated at 700° C. without vacuum oven (squares) and with drying in vacuum oven followed by heat treatment at 700° C. (diamonds).

FIG. 18 depicts a plot of battery capacity versus cycle number at −20° C. for copper-modified silicon electrodes heat treated at 700° C. without vacuum oven (squares, plot 1710) and with drying in vacuum oven followed by heat treatment at 700° C. (diamonds, plot 1700), in accordance with various embodiments. The cycle testing is for copper-modified silicon electrodes that underwent various heat treatment steps. Cells were tested for 100 cycles at −20° C. and at a 420 mA/g current density in DEE electrolyte. Silicon electrodes were heat treated at 700° C. without vacuum oven (squares) and with drying in vacuum oven followed by heat treatment at 700° C. (diamonds).

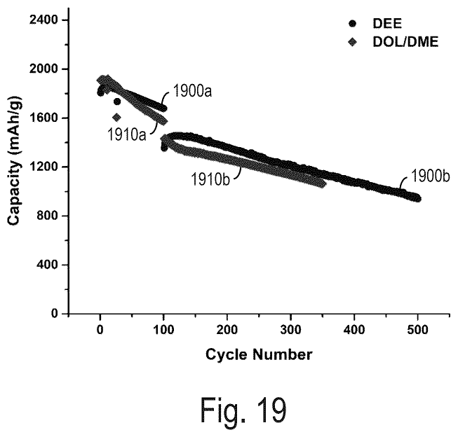

FIG. 19 depicts plots of an average life cycle performance of coin cells that were vacuum oven dried prior to heat treatment at 700° C. in DOL/DME and DEE (diamonds, plots 1910a and 1910b) and DEE (circles, plots 1900a and 1900b) electrolyte, in accordance with various embodiments. The average cycle life performance is for coin cells with silicon electrodes that were vacuum oven dried prior to heat treatment at 700° C. in DOL/DME+FEC (diamonds) and DEE (squares) electrolyte. This shows the entire cycle life average, from 100 cycles at room temperature (23° C.) to 250 cycles at −20° C. for DOL/DME+FEC, retaining over 1000 mAh/g capacity after a total of 350 cycles. The cells in DEE electrolyte retain almost 1000 mAh/g on average after 400 cycles at −20° C., for a total of 500 cycles.

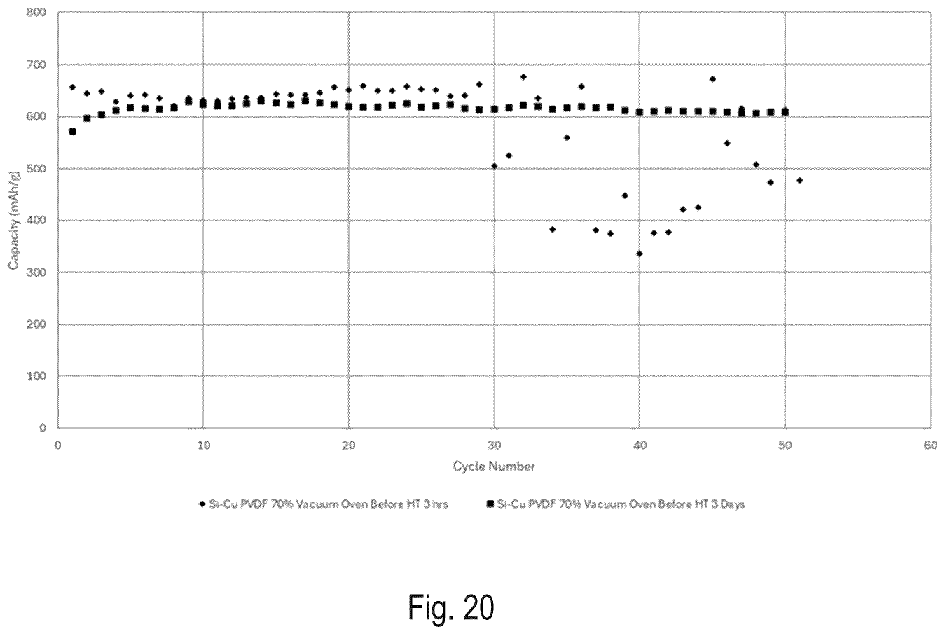

FIG. 20 depicts a plot of battery capacity versus cycle number at −30° C. for cells that soaked for 3 hours (diamonds) vs. 3 days (squares) before initial room temperature formation cycles, both in DOL/DME electrolyte, in accordance with various embodiments. The capacity is for silicon electrodes cycled at −30° C. for 50 cycles for cells that soaked for 3 hours vs. 3 days before initial room temperature formation cycles, both in DOL/DME electrolyte. An average of 600 mAh/g is shown for both sets of cells

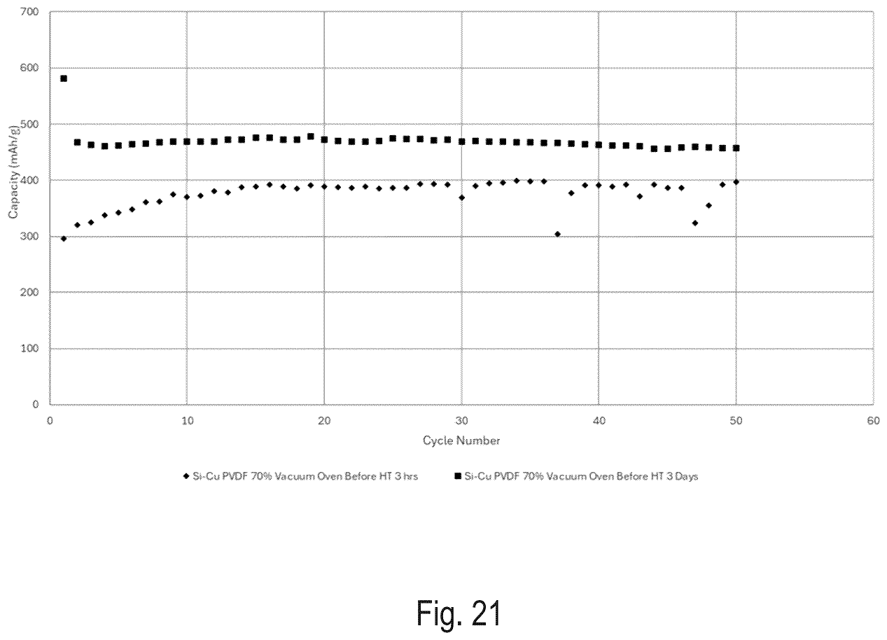

FIG. 21 depicts a plot of battery capacity versus cycle number at −40° C. for cells that soaked for 3 hours (diamonds) vs. 3 days (squares) before initial room temperature formation cycles, both in DOL/DME electrolyte, in accordance with various embodiments. The capacity is for silicon electrodes cycled at −40° C. for 50 cycles for cells that soaked for 3 hours vs. 3 days before initial room temperature formation cycles, both in DOL/DME electrolyte. An average of 470 mAh/g is shown for cells that soaked for 3 days vs. an average of 400 mAh/g in cells that soaked for 3 hours.

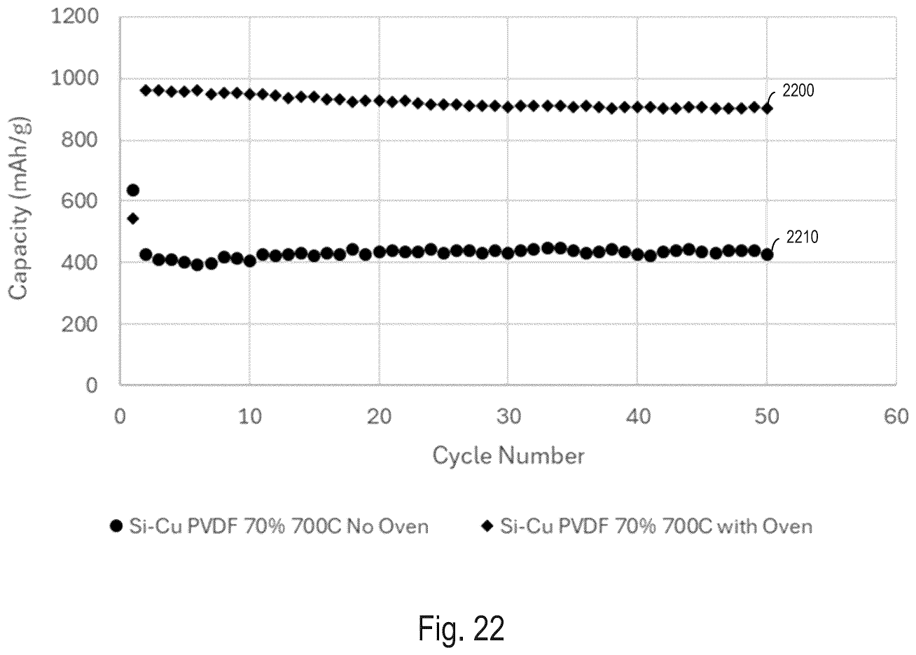

FIG. 22 depicts a plot of battery capacity versus cycle number at −30° C. for cells that contain silicon electrodes heat treated at 700° C. including vacuum oven drying (diamonds, plot 2200) and excluding vacuum oven drying (circles, plot 2210), both in DEE electrolyte, in accordance with various embodiments. The capacity is for silicon electrodes cycled at −30° C. for 50 cycles for cells that contain silicon electrodes heat treated at 700° C. including vacuum oven drying and excluding vacuum oven drying, both in DEE electrolyte. An average of 900 mAh/g is shown for cells that have electrodes that included vacuum oven drying prior to heat treatment vs an average of 400 mAh/g in cells that have electrodes that didn't incorporate oven drying before heat treatment.

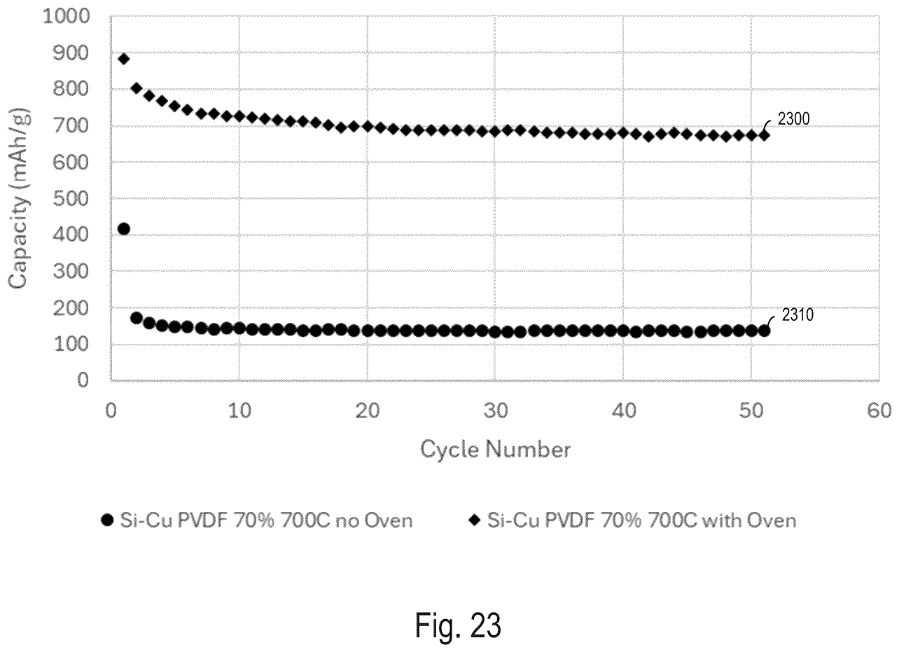

FIG. 23 depicts a plot of battery capacity versus cycle number at −40° C. for cells that contain silicon electrodes heat treated at 700° C. including vacuum oven drying (diamonds, plot 2300) and excluding vacuum oven drying (circles, plot 2310), both in DEE electrolyte, in accordance with various embodiments. The capacity is for silicon electrodes cycled at −40° C. for 50 cycles for cells that contain silicon electrodes heat treated at 700° C. including vacuum oven drying and excluding vacuum oven drying, both in DEE electrolyte. An average of almost 700 mAh/g is shown for cells that have electrodes that included vacuum oven drying prior to heat treatment vs. an average of approximately 100 mAh/g in cells that have electrodes that didn't incorporate oven drying before heat treatment.

### 4. Conclusion

While silicon electrodes are still being optimized for room temperature cycling, the demand for use in lower temperature applications is quickly increasing. Examining all of the factors which have improved the low temperature performance of traditional lithium-ion batteries and combining them with factors that have improved performance of lithium metal and silicon electrodes is a sizeable challenge. Here we have combined not only the optimization of the electrolyte for low temperature purposes, but the optimization of electrolyte compatible with lithium metal at low temperatures. We have further investigated a copper-modified silicon electrode put through different drying and heat treatment processes and paired it with lithium metal and optimized ether electrolyte to demonstrate high discharge and charge capacity at −20° C. after 100 cycles at moderate currents. This work explored the influence of various heat treatment processes and found a certain drying step followed by heat treatment of the silicon electrode yielding a discharge capacity nearly 10 times higher than traditional lithium-ion electrodes after 100 cycles at −20° C. We believe, to the best of our knowledge, this to be the highest discharge capacity of a next generation silicon electrode reported at this temperature and for this many cycles at moderate current density, which we also believe likely due to the formation of a Si—C/Cu network. Analysis of different drying and heat treatment steps on the morphology of a copper-modified silicon electrode using different binders could further increase discharge capacity at −20° C. or deliver high discharge capacity at ever lower temperatures, greatly fulfilling the needs of the electric car and aerospace industry among other applications.

In the detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Some non-limiting examples of various embodiments are presented below.

Example 1 includes a lithium-ion battery comprising: a lithium metal electrode; a copper-modified silicon electrode comprising silicon nanoparticles, copper nanoparticles, a binder product, and conductive carbon; a low-temperature electrolyte system; and a separator.

Example 2 includes the lithium-ion battery of Example 1, wherein the copper nanoparticles are dispersed in silicon to form a Cu₃Si phase.

Example 3 includes the lithium-ion battery of Example 1 or 2, wherein the copper nanoparticles and the silicon nanoparticles are under 1000 nm in size.

Example 4 includes the lithium-ion battery of any one of Examples 1-3, wherein a

majority of the copper nanoparticles and the silicon nanoparticles are about 10nm to about 250 nm in size.

Example 5 includes the lithium-ion battery of any one of Examples 1-3, wherein a majority of the copper nanoparticles and the silicon nanoparticles are about 20 nm to about 150 nm in size.

Example 6 includes the lithium-ion battery of any one of Examples 1-5, wherein the binder product is a decomposition or carbonized product of polyvinylpyrrolidone (PVP).

Example 7 includes the lithium-ion battery of any one of Examples 1-5, wherein the binder product is a decomposition or carbonized product of polyvinylidene fluoride (PVDF).

Example 8 includes the lithium-ion battery of any one of Examples 1-7, wherein the low-temperature electrolyte system improves performance of lithium metal from ambient to −30° C.

Example 9 includes the lithium-ion battery of any one of Examples 1-8, wherein the low-temperature electrolyte system comprises one or more ether-based electrolyte.

Example 10 includes the lithium-ion battery of any one of Examples 1-9, wherein the electrolyte system comprises 1,3-dioxolane (DOL) and 1,2-dimethoxyethane (DME) with fluoroethylene carbonate as an additive.

Example 11 includes the lithium-ion battery of Example 10, wherein the DOL and the DME are in about a 4:1 by volume ratio.

Example 12 includes the lithium-ion battery of Example 10 or 11, wherein the fluoroethylene carbonate comprises about 10% by mass of the electrolyte system.

Example 13 includes the lithium-ion battery of any one of Examples 10-12, further comprising a lithium salt.

Example 14 includes the lithium-ion battery of Example 13, wherein the lithium salt comprises at least one of lithium bis(trifluoromethane)sulfonimide (LiTFSI) salt and lithium nitrate.

Example 15 includes the lithium-ion battery of Example 14, wherein the LiTFSI salt and the lithium nitrate are about a 0.8M and 0.2M concentration, respectively.

Example 16 includes the lithium-ion battery of any one of Examples 1-15, wherein the electrolyte system comprises lithium bis(fluorosulfonyl)imide salt (LiFSI) dissolved in diethyl ether.

Example 17 includes the lithium-ion battery of any one of Examples 1-16, wherein the separator is a porous membrane.

Example 18 includes a lithium-ion battery comprising: a lithium metal electrode; a copper-modified silicon electrode comprising silicon nanoparticles, copper nanoparticles, a binder product, and conductive carbon; wherein the copper nanoparticles and the silicon nanoparticles are under 1000 nm in size; and an ether-based electrolyte system; and a separator.

Example 19 includes the lithium-ion battery of Example 18 wherein the battery retains capacity from ambient to −30° C.

Example 20 includes a method for fabricating the copper-modified silicon electrode in Example 18, comprising: combining the silicon nanoparticles, a binder, the conductive carbon and a metal additive in a solvent to form a slurry; casting the slurry onto a copper foil to form a film; and drying the film in a vacuum oven.

Example 21 includes the method of Example 20, further comprising mixing the slurry for at least 2 hours before the casting.

Example 22 includes the method of Example 20, wherein the drying is in the vacuum oven for at least 2 hours at a temperature of at least 100-120° C.

Example 23 includes the method of Example 20, further comprising heat treating the film after the drying.

Example 24 includes the method of Example 23, wherein the heat treating is at a temperature of at least 600° C. for at least 10 minutes.

Example 25 includes the method of Example 24, wherein the heat treating is at a temperature ramp rate of less than 20° C./min.

Example 26 includes the method of Example 24, wherein the heat treating is at a temperature ramp rate of about 4° C./minute.

Example 27 includes the method of Example 23, wherein the heat treating is at a temperature of at least 700° C. for at least 10 minutes.

Example 28 includes the method of Example 27, wherein the heat treating is at a ramp rate of less than 20° C./minute.

Example 29 includes the method of Example 27, wherein the heat treating is at a temperature ramp rate of about 4° C./minute.

Example 30 includes the method of any one of Examples 20-29, wherein the heat

treating is under an inert gas flow.

Example 31 includes the method of Example 30, wherein the inert gas is one of argon or nitrogen.

Example 32 includes the method of any one of Examples 20-31, wherein the solvent comprises N-Methyl-2-pyrrolidone (NMP).

Example 33 includes the method of any one of Examples 20-32, wherein the metal additive comprises anhydrous copper chloride.

Example 34 includes the method of any one of Examples 20-33, wherein the binder comprises polyvinylpyrrolidone (PVP).

Example 35 includes the method of any one of Examples 20-33, wherein the binder comprises polyvinylidene fluoride (PVDF).

Example 36 includes the method of any one of Examples 20-33, wherein the binder comprises at least 30% of total mass of the slurry, excluding mass of the solvent.

Example 37 includes the method of any one of Examples 20-33, wherein the binder comprises at least 50% of total mass of the slurry, excluding mass of the solvent.

Example 38 includes the method of any one of Examples 20-33, wherein the binder comprises at least 65-75% of total mass of the slurry, excluding mass of the solvent.

Example 39 includes a method for fabricating a copper-modified silicon electrode comprising silicon nanoparticles, copper nanoparticles, a binder product, and conductive carbon in a lithium-ion battery, comprising: combining the silicon nanoparticles, a binder, conductive carbon and a metal additive in a solvent to form a slurry; casting the slurry onto a copper foil to form a film; and drying the film in a vacuum oven.

Example 40 includes the method of Example 39, wherein the lithium-ion battery comprises an ether-based electrolyte system and a separator.

Example 41 includes the method of Example 39, wherein the lithium-ion battery retains capacity from ambient to −30° C.

Example 42 includes a lithium-ion battery, comprising: a lithium metal electrode; a copper-modified silicon electrode comprising silicon nanoparticles, copper nanoparticles, a binder product, and conductive carbon; a low-temperature electrolyte system; and a separator.

Example 43 includes the lithium-ion battery of Example 42, wherein the copper nanoparticles are dispersed in silicon to form a Cu₃Si phase.

Example 44 includes the lithium-ion battery of Example 42 or 43, wherein the copper nanoparticles and the silicon nanoparticles are under 700 nm in size.

Example 45 includes the lithium-ion battery of Example 42 or 43, wherein the copper nanoparticles and the silicon nanoparticles are about 10 nm to about 350 nm in size.

Example 46 includes the lithium-ion battery of any one of Examples 42-45, wherein the binder product is a decomposition or carbonized product of polyvinylpyrrolidone (PVP).

Example 47 includes the lithium-ion battery of any one of Examples 42-45, wherein the binder product is a decomposition or carbonized product of polyvinylidene fluoride (PVDF).

Example 48 includes the lithium-ion battery of any one of Examples 42-47, wherein the low-temperature electrolyte system maintains at least 30% capacity of a room temperature capacity at −30° C. after 50 cycles.

Example 49 includes the lithium-ion battery of any one of Examples 42-48, wherein the low-temperature electrolyte system comprises one or more ether-based electrolyte.

Example 50 includes the lithium-ion battery of any one of Examples 42-49, wherein the electrolyte system comprises 1,3-dioxolane (DOL) and 1,2-dimethoxyethane (DME) with fluoroethylene carbonate as an additive.

Example 51 includes the lithium-ion battery of Example 50, wherein the DOL and the DME are in about a 4:1 by volume ratio.

Example 52 includes the lithium-ion battery of Example 50 or 51, wherein the fluoroethylene carbonate comprises about 10% by mass of the electrolyte system.

Example 53 includes the lithium-ion battery of any one of Examples 50-52, further comprising a lithium salt, wherein the lithium salt comprises at least one of lithium bis(trifluoromethane)sulfonimide (LiTFSI) and lithium nitrate.

Example 54 includes the lithium-ion battery of any one of Examples 42-53, wherein the electrolyte system comprises lithium bis(fluorosulfonyl)imide salt (LiFSI) dissolved in diethyl ether.

Example 55 includes A lithium-ion battery comprising: a copper-modified silicon electrode comprising silicon nanoparticles, copper nanoparticles, a binder product, and conductive carbon; wherein: the copper nanoparticles are dispersed to form phases comprising copper and silicon; the copper nanoparticles and the silicon nanoparticles have a size of less than 700 nm; and the binder product comprises a decomposition product of polyvinylidene fluoride (PVDF).

Example 56 includes the lithium-ion battery of Example 55, wherein carbon is present in association with the copper and silicon phases.

Example 57 includes the lithium-ion battery of Example 55 or 56, wherein the copper and silicon phases contain Cu₃Si.

Example 58 includes A method for fabricating a copper-modified silicon electrode for a lithium-ion battery, comprising: combining silicon nanoparticles, a binder, conductive carbon and a copper salt in a solvent to form a slurry; casting the slurry onto a copper foil to form a film; drying the film in a vacuum oven at a temperature of at least 100° C.; and heat treating the dried film at a temperature of at least 600° C. under an inert atmosphere to form phases comprising silicon and copper.

Example 59 includes the method of Example 58, wherein silicon and copper phases comprise Cu₃Si.

Example 60 includes the method of Example 58 or 59, wherein the binder comprises polyvinylpyrrolidone (PVP) or polyvinylidene fluoride (PVDF), and the heat treating decomposes the binder to form a carbonized product.

Example 61 includes the method of any one of Examples 58-60, wherein the heat treating is performed at a temperature ramp rate of about 4° C./minute.

Example 62 includes the method of any one of Examples 58-61, wherein copper salt comprises anhydrous copper chloride.

Example 63 includes the method of any one of Examples 58-62, wherein the binder comprises at least 50% of total mass of the slurry, excluding mass of the solvent.

Example 64 includes the method of any one of Examples 58-62, wherein the binder comprises at least 65-75% of total mass of the slurry, excluding mass of the solvent.

Example 65 includes the method of any one of Examples 58-64, wherein the silicon nanoparticles have a size of about 10 nm to about 350 nm.

Example 66 includes the method of any one of Examples 58-65, further comprising assembling the copper-modified silicon electrode with a lithium metal electrode and an ether-based electrolyte system to form a lithium-ion battery.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A lithium-ion battery comprising:
a lithium metal electrode;
a copper-modified silicon electrode comprising silicon nanoparticles, copper nanoparticles, a binder product, and conductive carbon;
a low-temperature electrolyte system; and
a separator.

2. The lithium-ion battery of claim 1, wherein the copper nanoparticles are dispersed in silicon to form a Cu₃Si phase.

3. The lithium-ion battery of claim 1, wherein the copper nanoparticles and the silicon nanoparticles are under 700 nm in size.

4. The lithium-ion battery of claim 1, wherein the copper nanoparticles and the silicon nanoparticles are about 10 nm to about 350 nm in size.

5. The lithium-ion battery of claim 1, wherein the binder product is a decomposition or carbonized product of polyvinylpyrrolidone (PVP).

6. The lithium-ion battery of claim 1, wherein the binder product is a decomposition or carbonized product of polyvinylidene fluoride (PVDF).

7. The lithium-ion battery of claim 1, wherein the low-temperature electrolyte system maintains at least 30% capacity of a room temperature capacity at −30° C. after 50 cycles.

8. The lithium-ion battery of claim 1, wherein the low-temperature electrolyte system comprises one or more ether-based electrolyte.

9. The lithium-ion battery of claim 1, wherein the electrolyte system comprises 1,3-dioxolane (DOL) and 1,2-dimethoxyethane (DME) with fluoroethylene carbonate as an additive.

10. The lithium-ion battery of claim 9, wherein the DOL and the DME are in about a 4:1 by volume ratio.

11. The lithium-ion battery of claim 9, wherein the fluoroethylene carbonate comprises about 10% by mass of the electrolyte system.

12. The lithium-ion battery of claim 9, further comprising a lithium salt, wherein the lithium salt comprises at least one of lithium bis(trifluoromethane)sulfonimide (LiTFSI) and lithium nitrate.

13. The lithium-ion battery of claim 1, wherein the electrolyte system comprises lithium bis(fluorosulfonyl)imide salt (LiFSI) dissolved in diethyl ether.

14. A lithium-ion battery comprising:
a copper-modified silicon electrode comprising silicon nanoparticles, copper nanoparticles, a binder product, and conductive carbon; wherein:
the copper nanoparticles are dispersed to form phases comprising copper and silicon;
the copper nanoparticles and the silicon nanoparticles have a size of less than 700 nm; and
the binder product comprises a decomposition product of polyvinylidene fluoride (PVDF).

15. The lithium-ion battery of claim 14, wherein carbon is present in association with the copper and silicon phases.

16. The lithium-ion battery of claim 14, wherein the copper and silicon phases contain Cu₃Si.

17. A method for fabricating a copper-modified silicon electrode for a lithium-ion battery, comprising:
combining silicon nanoparticles, a binder, conductive carbon and a copper salt in a solvent to form a slurry;
casting the slurry onto a copper foil to form a film;
drying the film in a vacuum oven at a temperature of at least 100° C.; and
heat treating the dried film at a temperature of at least 600° C. under an inert atmosphere to form phases comprising silicon and copper.

18. The method of claim 17, wherein silicon and copper phases comprise Cu₃Si.

19. The method of claim 17, wherein the binder comprises polyvinylpyrrolidone (PVP) or polyvinylidene fluoride (PVDF), and the heat treating decomposes the binder to form a carbonized product.

20. The method of claim 17, wherein the heat treating is performed at a temperature ramp rate of about 4° C./minute.

21. The method of claim 17, wherein copper salt comprises anhydrous copper chloride.

22. The method of claim 17, wherein the binder comprises at least 50% of total mass of the slurry, excluding mass of the solvent.

23. The method of claim 17, wherein the binder comprises at least 65-75% of total mass of the slurry, excluding mass of the solvent.

24. The method of claim 17, wherein the silicon nanoparticles have a size of about 10 nm to about 350 nm.

25. The method of claim 17, further comprising assembling the copper-modified silicon electrode with a lithium metal electrode and an ether-based electrolyte system to form a lithium-ion battery.
